(19) United States
(12) Patent Application Publication
(10) Pub. No.: US 2006/0246215 A1
(43) Pub. Date: Nov. 2, 2006

(54) Method of fabricating display and apparatus for forming layer used for the method

(76) Inventors: Jin-soo Jung, Goyang-si (KR); Bong-woo Lee, Pyeongtaek-si (KR); Jong-sung Bae, Cheonan-si (KR); Baek-kyun Jeon, Yongin-si (KR); Yong-kuk Yun, Suwon-si (KR)

Correspondence Address: CANTOR COLBURN, LLP, 55 GRIFFIN ROAD SOUTH, BLOOMFIELD, CT, 06002, US

(21) Appl. No.: 11/412,214

(22) Filed: Apr. 26, 2006

(30) Foreign Application Priority Data
Apr. 29, 2005 (KR) 10-2005-0036290

(51) Int. Cl. B05D 5/12; B05C 5/00

(52) U.S. Cl. 427/58; 118/305; 118/313; 118/300

(57) ABSTRACT

A method of fabricating a liquid crystal display includes preparing a substrate having a matrix-type array of a plurality of stepped patterns having a predetermined pitch and forming a layer substantially covering the front surface of the substrate by ejecting a liquid material from an inkjet head portion onto the substrate in a state wherein a relative movement direction of the substrate to the inkjet head portion and one direction of the matrix-type array form an angle greater than 0 degrees and less than 90 degrees. An alignment layer formation apparatus used for the method is also provided.

This application claims priority to Korean Patent Application No. 10-2005-0036290, filed on April 29, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a method of fabricating a liquid crystal display (“LCD”) and an alignment layer formation apparatus used for the method. More particularly, the present invention relates to a method of fabricating an LCD which includes forming an alignment layer using inkjet printing technology, and an alignment layer formation apparatus used for the method.

2. Description of the Related Art

Liquid crystal molecules of a liquid crystal layer formed between a thin film transistor (“TFT”) array substrate and a color filter substrate of an LCD should have an alignment regulating force or a surface fixing force. To this end, an alignment layer is formed at a contact surface between the liquid crystal layer and each of the TFT array substrate and the color filter substrate and rubbed. In a liquid crystal cell process, the formation of an alignment layer for effectively orienting liquid crystal molecules within the liquid crystal layer is very important in association with image quality.

Recently, an inkjet printing technology was suggested as a method of forming a large-scale alignment layer. However, according to the inkjet printing technology for alignment layer formation, leveling of an alignment layer is difficult. That is, since the inkjet printing technology for alignment layer formation adopts the principle that an alignment material solution spontaneously diffuses after ejected from an inkjet head onto a substrate using an inkjet head with a large nozzle pitch (375 μm), it is difficult to form a uniform alignment layer as compared to a roll printing technology.

FIG. 1 illustrates the spacing of droplets of an alignment material solution to be ejected from an inkjet head onto a substrate during alignment layer formation using a conventional inkjet-based alignment layer formation apparatus. Referring to FIG. 1, abruptly stepped patterns, including recessed portions A and B, are uniformly arranged on a substrate. Generally, a currently available inkjet head has a nozzle pitch HP between nozzles of the inkjet head greater than a stepped pattern pitch OP between recessed portions A and B of the substrate. Thus, an alignment material solution 21 is excessively supplied to recessed portions A of the stepped patterns into which the alignment material solution 21 is directly ejected, whereas it is insufficiently supplied to recessed portions B of the stepped patterns into which the alignment material solution 21 is not directly ejected. When an excessive alignment material solution and an insufficient alignment material solution are alternately supplied to a full-field area of a substrate at regular intervals, a viewer may recognize the regular alternation of surplus with shortage of the alignment material solution as stripes formed on an LCD panel.

### BRIEF SUMMARY OF THE INVENTION

The present invention provides a method of fabricating a liquid crystal display (“LCD”) capable of preventing generation of stripes on a panel of the LCD.

The present invention also provides an alignment layer formation apparatus capable of preventing generation of stripes on a panel of the LCD.

According to exemplary embodiments of the present invention, there is provided a method of fabricating a liquid crystal display, the method including preparing a substrate including a matrix-type array of a plurality of stepped patterns having a predetermined pitch and forming a layer substantially covering the front surface of the substrate by ejecting a liquid material from an inkjet head portion onto the substrate in a state wherein a relative movement direction of the substrate to the inkjet head portion and a first direction of the matrix-type array form an angle greater than 0 degrees and less than 90 degrees.

According to other exemplary embodiments of the present invention, there is provided a method of fabricating a liquid crystal display, the method including preparing a substrate including a matrix-type array of a plurality of stepped patterns having a predetermined pitch, and forming an alignment layer on the substrate by ejecting an alignment material solution from an inkjet head portion onto the substrate in a state wherein a relative movement direction of the substrate to the inkjet head portion and a first direction of the matrix-type array form an angle greater than 0 degrees and less than 90 degrees.

According to yet other aspect of the present invention, there is provided an apparatus for forming a layer, the apparatus including a stage moving a substrate disposed thereon in a first direction, the substrate including a thin film transistor array in which a plurality of thin film transistors are arranged in a matrix; and an inkjet head portion, positioned above the stage, ejecting a liquid material onto the substrate, wherein a relative movement direction of the substrate to the inkjet head portion and one direction of the thin film transistor array form an angle greater than 0 degrees and less than 90 degrees.

According to yet other exemplary embodiments of the present invention, there is provided an apparatus for forming an alignment layer on a substrate, the substrate including a thin film transistor array in which a plurality of thin film transistors are arranged in a matrix, the apparatus including a stage moving the substrate disposed thereon in a first direction, and an inkjet head portion, positioned above the stage, ejecting an alignment material solution onto the substrate, wherein a relative movement direction of the substrate to the inkjet head portion and one direction of the thin film transistor array form an angle greater than 0 degrees and less than 90 degrees.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram illustrating a conventional alignment layer formation apparatus;

FIG. 2 is a schematic diagram illustrating an exemplary embodiment of an alignment layer formation apparatus according to the present invention;

FIGS. 3A and 3B are bottom perspective views of an exemplary inkjet head portion contained in an exemplary embodiment of an alignment layer formation apparatus according to the present invention;

FIGS. 4A and 4B illustrate a schematic sectional view and a partially enlarged view, respectively, of an exemplary LCD manufactured according to an exemplary method of the present invention;

FIGS. 5 through 6B illustrate an exemplary alignment layer formation process in an exemplary embodiment of a method of fabricating an exemplary LCD according to the present invention; and

FIGS. 7 through 8C illustrate an exemplary alignment layer formation process in another exemplary embodiment of a method of fabricating an exemplary LCD according to the present invention.

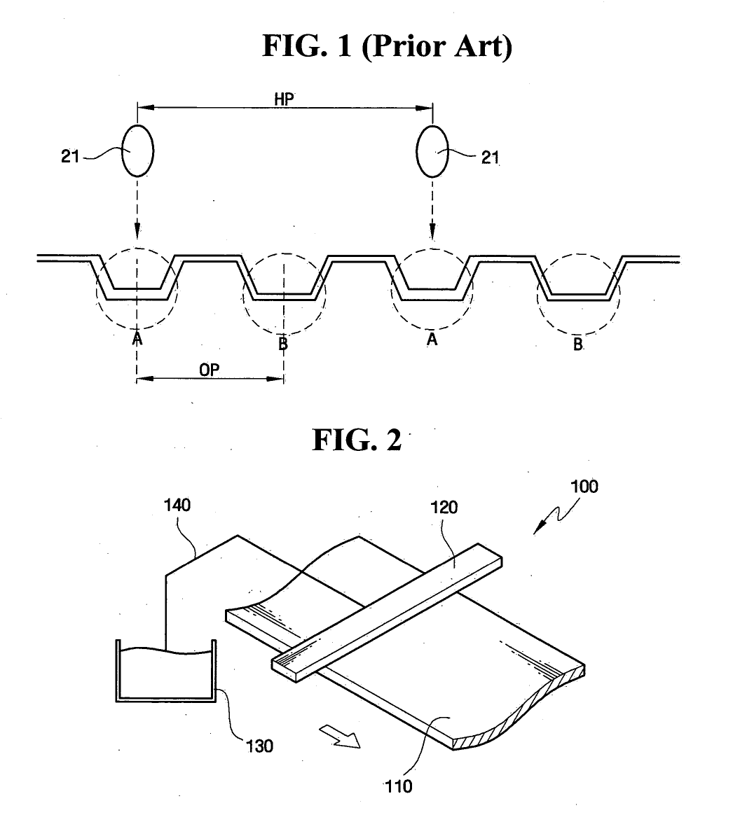

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

First, exemplary embodiments of an alignment layer formation apparatus used for forming an alignment layer of an exemplary liquid crystal display (“LCD”) manufactured according to the present invention will be described.

FIG. 2 is a schematic diagram illustrating an exemplary embodiment of an alignment layer formation apparatus 100 according to the present invention. Referring to FIG. 2, the alignment layer formation apparatus 100 includes a stage 110, an inkjet head portion 120, an alignment material solution storage portion 130, and an alignment material solution supply pipe 140.

The stage 110 provides a surface where a substrate, such as a thin film transistor (“TFT”) array substrate or a color filter substrate of an LCD panel, may be located, and moves the substrate in one direction, such as a movement direction as indicated by the arrow. The stage 110 may also move other substrates not particularly described herein. The form of the stage 110 is not particularly limited to the illustrated embodiment, and may include any form that can move the substrate. For example, the stage 110 may be in the form of a conveyor belt.

The inkjet head portion 120 allows ejecting of an alignment material solution from the inkjet head portion 120 onto a substrate disposed on the stage 110 as the substrate moves underneath the inkjet head portion 120. The inkjet head portion 120 is composed of at least one head, as will be further described below.

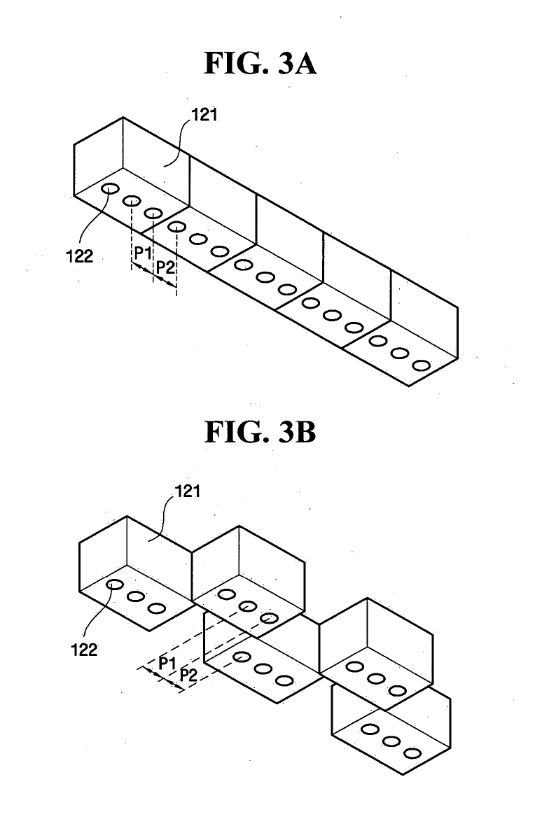

FIGS. 3A and 3B are bottom perspective views of an exemplary inkjet head portion contained in an exemplary embodiment of an alignment layer formation apparatus according to the present invention. Referring to FIG. 3A, an inkjet head portion 120, as shown in FIG. 2, may have a linear array of a plurality of block-shaped heads 121, each including a plurality of nozzles 122. Adjacent nozzles on a same head 121 are separated by a pitch P1, and adjacent nozzles between adjacent heads 121 are separated by a pitch P2. In an exemplary embodiment of the inkjet head portion 120, the nozzles 122 are equidistantly separated, and therefore P1 is preferably substantially equal to P2.

To easily adjust a pitch P1 between two adjacent nozzles 122 of the same head 121 so as to conform to a pitch P2 between two adjacent nozzles of two adjacent heads 121, the plurality of the heads 121 may be arranged in a zig-zag form in such a way that ends of adjacent heads 121 overlap with each other, as shown in FIG. 3B. In this case, while the pitches P1 and P2 between adjacent nozzles 122 formed at an entire area of the inkjet head portion 120 are easily adjusted equidistantly, the plurality of the heads 121 can be compactly arranged. As will be further described below, a pitch P1 or P2 between adjacent nozzles 122 of the inkjet head portion 120 is greater than a pitch between stepped patterns formed on a TFT array substrate. Here, the nozzles 122 can be independently opened or closed, and thus, areas of a substrate intended for alignment material solution ejecting and an ejecting amount of an alignment material solution onto the areas of the substrate can be adjusted and controlled. Furthermore, the process duration for alignment layer formation on a substrate can be controlled by adjusting the number of nozzles 122 on the inkjet head portion 120.

The inkjet head portion 120 can be effectively employed in alignment layer formation on a large-scale substrate by increasing the number of inkjet heads 121. In particular, the total length of the inkjet head portion 120 is preferably adjusted to be at least greater than a width of a substrate, i.e., where the width of the substrate is measured in a perpendicular direction relative to the movement direction of the substrate.

With reference again to FIG. 2, the inkjet head portion 120 is positioned in such a way that the lengthwise direction of the inkjet head portion 120 is perpendicular to the movement direction of the stage 110. The inkjet head portion 120 may be fixed, that is not movable, or may instead be reciprocally movable in a substantially perpendicular direction relative to the movement direction of a substrate, such as movable in the lengthwise direction of the inkjet head portion 120. In a case where the inkjet head portion 120 moves reciprocally, an alignment material solution is ejected from the inkjet head portion 120 onto a substrate in a state wherein the movement direction of the substrate relative to the inkjet head portion 120 and a first direction of a matrix-type array of TFTs form an angle greater than 0 degrees and less than 90 degrees, as will be further described below with respect to a process of forming an alignment layer using the alignment layer formation apparatus 100.

The alignment material solution storage portion 130 stores an alignment material solution to be supplied to the inkjet head portion 120. For example, the alignment material solution contained in the alignment material solution storage portion 130 may be, but is not limited to, a polyimide solution.

The alignment material solution supply pipe 140 connects the inkjet head portion 120 and the alignment material solution storage portion 130 to supply the alignment material solution from the alignment material solution storage portion 130 to the inkjet head portion 120.

Hereinafter, an exemplary method of fabricating an LCD in which an alignment layer is formed using the alignment layer formation apparatus 100 shown in FIG. 2 will be described.

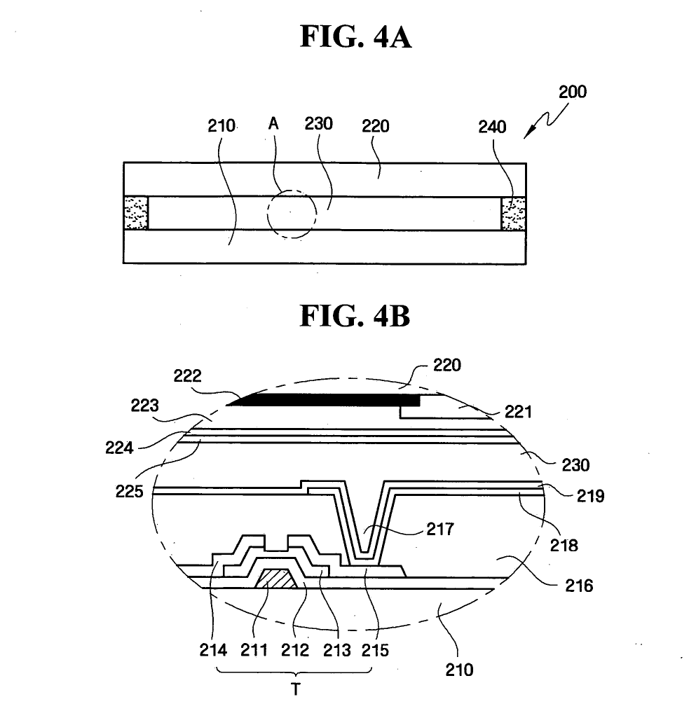

FIGS. 4A shows a schematic sectional view of an LCD manufactured according to an exemplary method of the present invention, and FIG. 4B shows a partially enlarged view of portion A of FIG. 4A. Referring to FIG. 4, an LCD 200 includes a TFT array substrate 210, a color filter-substrate 220, and a liquid crystal layer 230 interposed between the TFT array substrate 210 and the color filter substrate 220.

The TFT array substrate 210 is a driving device array substrate, and includes a plurality of pixels arranged in a matrix configuration thereon. A driving device such as a thin film transistor T is formed on each pixel. The color filter substrate 220 includes a color filter layer 221 for embodying coloration. A pixel electrode 218 and a common electrode 224 are respectively formed on the TFT array substrate 210 and the color filter substrate 220. Alignment layers 219 and 225 for orienting liquid crystal molecules of the liquid crystal layer 230 are formed to a thickness of about 500 to 1,000 A on the TFT array substrate 210 and the color filter substrate 220, respectively.

The TFT array substrate 210 and the color filter substrate 220 are assembled with the liquid crystal layer 230 interposed therebetween using a sealant 240. When the liquid crystal molecules are driven by the driving device formed on the TFT array substrate 210, the LCD 200 displays information by adjusting the amount of light transmitted through the liquid crystal layer 230.

A method of fabricating the LCD 200 can be divided into basic processes including, but not limited to, a driving device array substrate process in which driving devices are formed on the TFT array substrate 210, a color filter substrate process in which a color filter is formed on the color filter substrate 220, and a liquid crystal cell process in which two substrates manufactured in the driving device array substrate process and the color filter substrate process are assembled together.

First, a plurality of gate lines (not shown), arranged parallel to each other, and a plurality of data lines (not shown), arranged parallel to each other and substantially perpendicularly to the gate lines, are formed on the TFT array substrate 210 according to a driving device array process. Pixel areas are defined between adjacent pairs of gate lines and adjacent pairs of data lines. TFTs T, which are driving devices connected to the gate lines and the data lines, are arranged in a matrix on the pixel areas to form a TFT array. Here, each TFT T includes a gate electrode 211, a gate insulating layer 212, a semiconductor layer 213 made of an amorphous silicon (“a-Si”) material, and source and drain electrodes 214 and 215.

An organic layer 216 may be formed on the TFT array substrate 210 including the TFT array using, by example only, benzocyclobutene (“BCB”), etc. Then, a plurality of stepped patterns 217, e.g., contact holes, are uniformly formed in the organic layer 216 along the TFT array to expose a surface of the drain electrode 215 of each TFT T of the TFT array. The organic layer 216 is formed on at least substantially the entire surface of the TFT array substrate 210 having the TFT array since the organic layer 216 has a low effective dielectric constant and is capable of planarizing a stepped surface of the TFT array substrate 210, thereby advantageously enhancing the aperture ratio of a pixel. That is, even though the pixel electrode 218 overlaps with the data lines, etc., to maximize the aperture ratio of a pixel, a voltage flowing in the data lines does not affect pixels due to a high insulating property of the organic layer 216, thereby preventing the distortion of a pixel voltage. Furthermore, due to its flat surface, the organic layer 216 can uniformly maintain a cell gap between the TFT array substrate 210 and the color filter substrate 220 and reduce poor rubbing of the alignment layer 219 formed on the pixel electrode 218. The organic layer 216 may have a thickness of 3 μm or more, for example 3 to 4 μm. Thus, the stepped pattern 217 formed by patterning the organic layer 216 has a step height of 3 μm or more, for example 3 to 4 μm. A pitch between the plurality of the stepped patterns 217 may be about 170 μm, but is not limited thereto.

An inorganic layer made of, by example only, indium tin oxide (“ITO”) is deposited on the stepped pattern 217 and portions of the organic layer 216 by sputtering, etc. and patterned to thereby form the pixel electrode 218 connected to the drain electrode 215 of the TFT T and driving the liquid crystal layer 230 according to an applied signal through the TFT T.

Also, a black matrix 222 is formed on the color filter substrate 220 by a color filter process, and the color filter layer 221 for embodying red (R), green (G), and blue (B) colors, or other desired colors, is then formed on an area of the color filter substrate 220 corresponding to a pixel area. Then, a planarization film 223 is formed to planarize a stepped surface between the black matrix 222 and the color filter layer 221, and the common electrode 224 is formed on the planarization film 223.

Next, the alignment layers 219 and 225 are respectively formed on the TFT array substrate 210 and the color filter substrate 220. The formation of the alignment layer 219 for the TFT array substrate 210 can be performed in the same manner as the formation of the alignment layer 225 for the color filter substrate 220. Thus, only the formation of the alignment layer 219 for the TFT array substrate 210 will be illustrated herein for convenience of illustration. However, it should be understood that the formation of the alignment layer 219 for the TFT array substrate 210 could be applied for the formation of the alignment layer 225 for the color filter substrate 220.

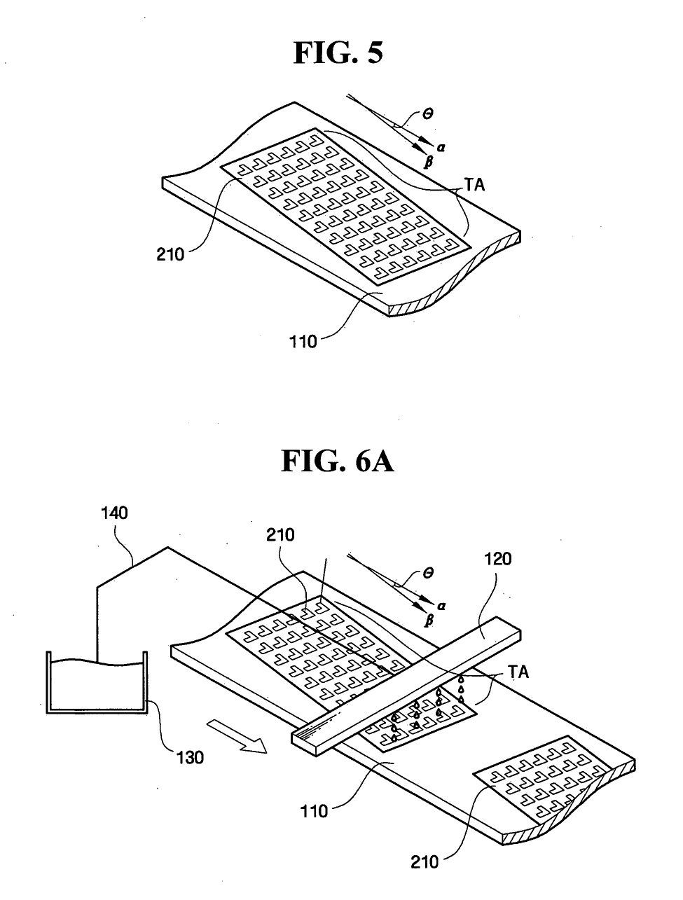

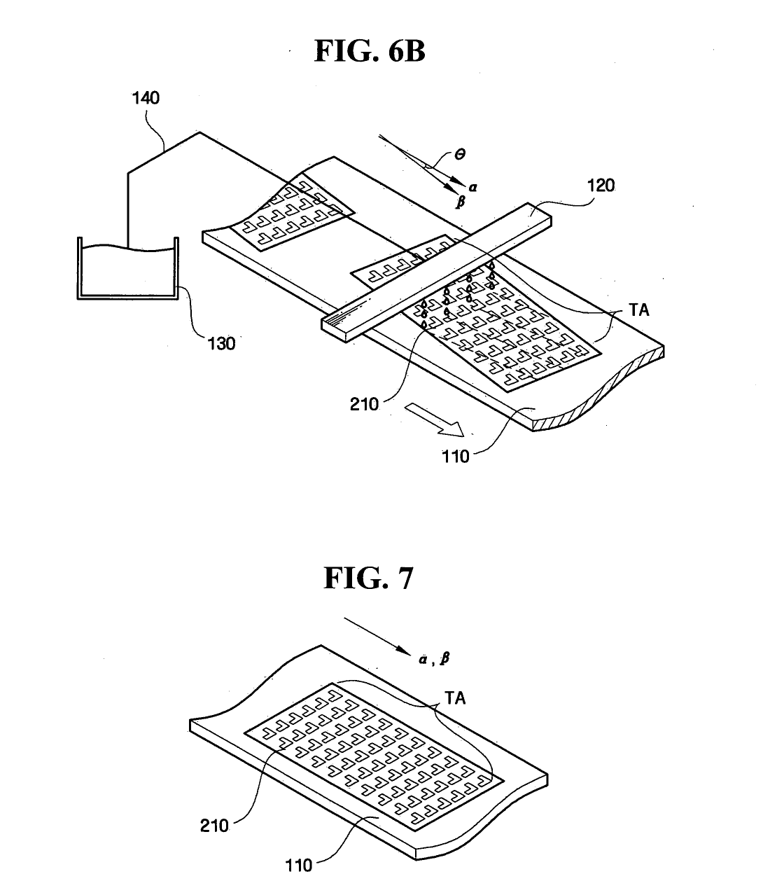

FIGS. 5 through 6B illustrate an exemplary alignment layer formation process in an exemplary embodiment of a method of fabricating an LCD according to the present invention. Hereinafter, a process of forming an alignment layer on a TFT array substrate will be further described with reference to FIGS. 5 through 6B.

An alignment layer can be formed using the alignment layer formation apparatus 100 shown in FIG. 2. Referring first to FIG. 5, a TFT array substrate 210 including a TFT array TA, in which TFTs are arranged in a matrix, is disposed on a stage 110 of an alignment layer formation apparatus 100.

The TFT array substrate 210 includes the TFT array TA formed by a driving device array process as described above and a plurality of stepped patterns 217, as shown in FIG. 4, formed along the TFT array TA. The TFT array TA has been schematically illustrated as an array of pixel electrodes 218, as previously described with respect to FIG. 4, formed on TFTs T.

The TFT array substrate 210 is disposed on the stage 110 in such a manner that an angle (θ) formed between the movement direction (α) of the stage 110 and the TFT array substrate 210 and a first direction, e.g., a row direction (β) of the TFT array TA is greater than 0 degrees and less than 90 degrees, e.g., from 3 to 45 degrees. If the angle (θ) formed between the movement direction (α) of the stage 110 and the TFT array substrate 210 and the row direction (β) of the TFT array TA is an obtuse angle, the supplementary angle to the obtuse angle, i.e., an angle greater 0 degrees and less than 90 degrees, e.g., an angle ranging from 3 to 45 degrees, is selected. Preferably, however, the angle (θ) formed between the movement direction (α) of the stage 110 and the TFT array substrate 210 and the row direction (β) of the TFT array TA ranges from 3 to 45 degrees considering the number of heads 121 contained in an alignment layer formation apparatus 100 and fabrication costs and maintenance costs of the alignment layer formation apparatus 100 according to an increase in the number of heads 121.

The TFT array substrate 210 is disposed at the angle θ on the stage 110 for preventing stripes from being generated on the TFT array substrate 210 as will be described below.

The TFT array substrate 210 includes a plurality of stepped patterns 217, as shown in FIG. 4, formed along the TFT arrays TA, and the plurality of the stepped patterns 217 are separated from each other by a predetermined pitch. The pitch P1, P2 between nozzles 122, shown in FIGS. 3A and 3B, of an inkjet head portion 120 of an alignment layer formation apparatus 100 is greater than the pitch between the stepped patterns 217. For example, the pitch between the stepped patterns 217 may be about 170 μm and the pitch P1, P2 between the nozzles 122 of the inkjet head portion 120 may be about 375 μm. In this case, if the TFT array substrate 210 moves in a movement direction (α) parallel to the row direction (β) of the TFT array TA, in other words when the angle (θ) equals zero, while an alignment material solution from the fixed inkjet head portion 120 is ejected onto the TFT array substrate 210, the stepped patterns 217 onto which the alignment material solution is directly ejected from the inkjet head portion 120 undergo a surplus in alignment material solution but the stepped patterns 217 on which the alignment material solution is not directly ejected from the inkjet head portion 120 undergo a deficiency in alignment material solution. The regular alternation of surplus with shortage of the alignment material solution results in a thickness deviation of an alignment layer formed on the TFT array substrate 210, thereby producing stripes on the TFT array substrate 210.

In the exemplary embodiments of FIGS. 5 to 6B, however, the movement direction (α) of the stage 110 and the TFT array substrate 210 is not parallel to the row direction (β) of the TFT array TA. Thus, the TFT array substrate 210 is oriented at the angle (θ) with respect to the movement direction (α) of the TFT array substrate 210 as shown in FIG. 5. Therefore, when an alignment material solution from an inkjet head portion 120 is ejected onto the TFT array substrate 210, the ejecting amount of the alignment material solution onto stepped patterns 217 arranged along the row direction (β) of the TFT array TA is not constant. Consequently, it is possible to prevent stripes from being generated on the TFT array substrate 210 which would otherwise occur due to regular alternation of surplus with shortage of the alignment material solution.

Referring to FIGS. 6A and 6B, an alignment material solution is ejected from the inkjet head portion 120 onto a TFT array substrate 210 by moving a stage 110 in the movement direction (α) while the inkjet head portion 120 is fixed. When nitrogen gas (N₂) is supplied to the alignment material solution storage portion 130 storing the alignment material solution, an inner pressure of the alignment material solution storage portion 130 is increased by the nitrogen gas. Through the increased inner pressure, the alignment material solution is supplied to the inkjet head portion 120 via the alignment material solution supply pipe 140. The alignment material solution is ejected from the inkjet head portion 120 onto the TFT array substrate 210 via nozzles 122 formed at heads 121, as previously shown in FIGS. 3A and 3B, of the inkjet head portion 120. The alignment material solution ejected from the nozzles 122 forms an alignment layer on the TFT array substrate 210.

After forming alignment layers 219 and 225, shown in FIG. 4, the alignment layers may be rubbed to impart an alignment regulating force or a surface fixing force to liquid crystal molecules of the liquid crystal layer 230 formed between the TFT array substrate 210 and the color filter substrate 220.

Next, the sealant 240 is coated on a periphery of at least one of the color filter substrate 220 and the TFT array substrate 210, the TFT array substrate 210 is assembled with the color filter substrate 220, a liquid crystal material is injected into a cell gap between the two substrates 210 and 220, and the sealant 240 is cured so that the color filter substrate 220 and the TFT array substrate 210 are fused together preventing leakage of the liquid crystal material contained therebetween, to thereby complete the LCD 200.

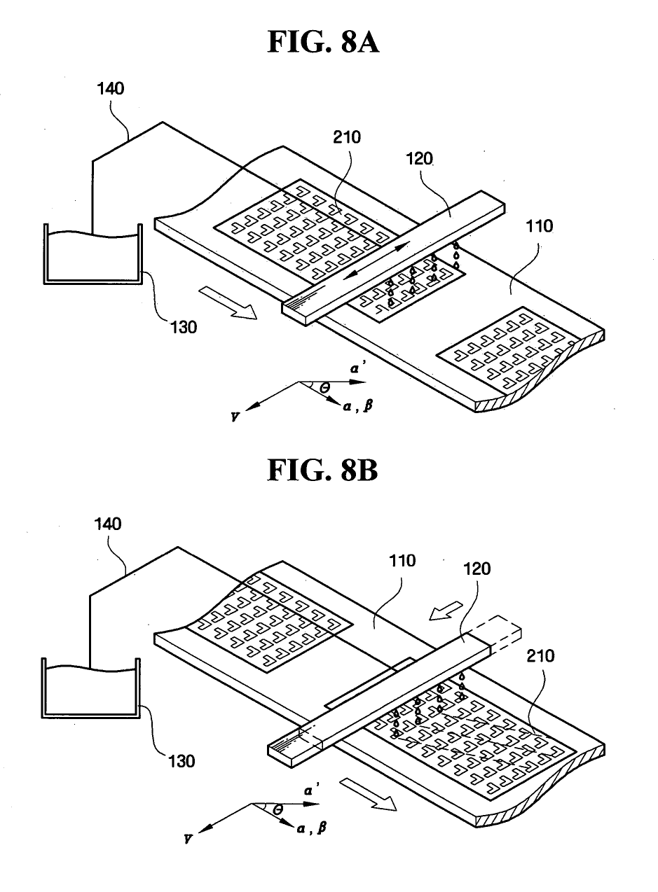

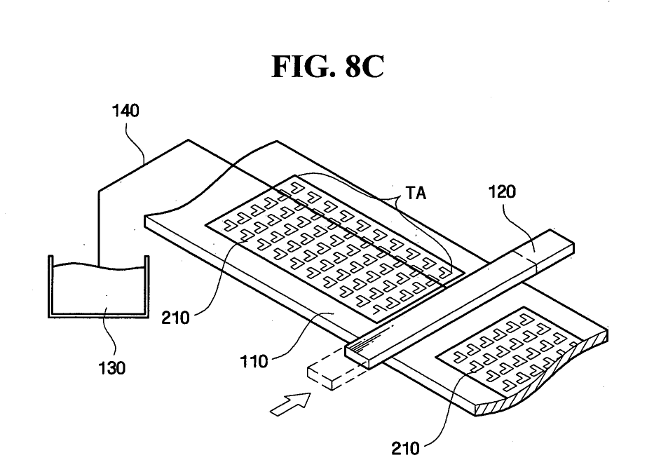

Hereinafter, another exemplary embodiment of a method of fabricating an exemplary LCD according to the present invention will be described with reference to FIGS. 7 through 8C. The method of fabricating the LCD according to this embodiment is substantially the same as that of the previous embodiment except for an alignment layer formation process, and thus, the overlapped description thereof will be omitted for convenience of illustration.

First, a TFT array substrate 210 and a color filter substrate 220 are manufactured according to the same driving device array substrate process and color filter substrate process as previously described with respect to the previous embodiment.

Next, an alignment layer 219, 225 is formed on each of the TFT array substrate 210 and the color filter substrate 220, respectively. For convenience of illustration, the formation of the alignment layer 219 for the TFT array substrate 210 will now be described.

The alignment layer 219 can be formed using the alignment layer formation apparatus 100 shown in FIG. 2. Referring first to FIG. 7, a TFT array substrate 210 including a TFT array TA, which is a matrix-type array of TFTs, is disposed on a stage 110 of an alignment layer formation apparatus 100.

The TFT array substrate 210 includes the TFT array TA and a plurality of stepped patterns 217, as shown in FIG. 4, formed along the TFT array TA. The TFT array substrate 210 is disposed on the stage 110 in such a way that the movement direction (α) of the TFT array substrate 210 is parallel to a first direction, e.g., a row direction (β) of the TFT array TA.

Then, an alignment material solution is ejected from the inkjet head portion 120 onto the TFT array substrate 210 while moving the stage 110 in a manner as will be further described below.

Referring to FIGS. 8A through 8C, to prevent generation of stripes on a display panel of the LCD 200 due to regular alternation of surplus with shortage of the alignment material solution in a plurality of stepped patterns 217 aligned along a TFT array TA, an inkjet head portion 120 is moved in a second direction different from the first direction, the row direction (β), of the TFT array TA. That is, the inkjet head portion 120 is moved in a substantially perpendicular direction (γ) relative to the row direction (β) of the TFT array TA.

To move the inkjet head portion 120 in a substantially perpendicular direction (γ) relative to the row direction (β) of the TFT array TA, a movement direction (α′) of the TFT array substrate 210 relative to the inkjet head portion 120 and the row direction (β) of the TFT array TA may form an angle (θ) greater than 0 degrees and less than 90 degrees, for example, from 3 to 45 degrees. When the movement direction (α′) of the TFT array substrate 210 relative to the inkjet head portion 120 and the row direction (β) of the TFT array TA forms an obtuse angle, the supplementary angle to the obtuse angle, i.e., an angle greater 0 degrees and less than 90 degrees, e.g., an angle ranging from 3 to 45 degrees is selected. As used herein, the phrase “movement direction (α′) of the TFT array substrate 210 relative to the inkjet head portion 120” indicates a relative movement direction between the TFT array substrate 210 and the inkjet head portion 120. Thus, the relative movement direction (α′) of the TFT array substrate 210 to the inkjet head portion 120 can be determined by subtraction of the movement direction (γ) of the inkjet head portion 120 from the movement direction (α) of the TFT array substrate 210.

The angle (θ) formed between the relative movement direction (α′) of the TFT array substrate 210 to the inkjet head portion 120 and the row direction (β) of the TFT array TA can be controlled by adjusting the movement velocity of the inkjet head portion 120 and the movement velocity of the TFT array substrate 210. That is, if two of the three parameters of a desired value of the angle (θ), the movement velocity of the inkjet head portion 120, and the movement velocity of the TFT array substrate 210 are known, then the remaining parameter can be determined by the following Equation:

$$θ = {tan}^{- 1} \frac{Movement velocity of inkjet header}{Movement velocity of TFT array substrate}$$

For example, if a desired value of the angle (θ) between the relative movement direction (α′) of the TFT array substrate 210 to the inkjet head portion 120 and the row direction (β) of the TFT array TA is about 5 degrees, it can be accomplished by moving the inkjet head portion 120 at a velocity of 17.5 mm/sec and the TFT array substrate 210 at a velocity of 200 mm/sec in a substantially perpendicular direction to the movement direction of the inkjet head portion 120.

When the relative movement direction (α′) of the TFT array substrate 210 to the inkjet head portion 120 is not parallel to the row direction (β) of the TFT array TA, the ejecting amount of an alignment material solution from the inkjet head portion 120 onto the stepped patterns 217 aligned along the row direction (β) of the TFT array TA is not constant. Therefore, generation of stripes on a display panel of LCD 200, which would otherwise occur due to regular alternation of surplus with shortage of the alignment material solution as described above, can be prevented.

When the ejecting of an alignment material solution from the inkjet head portion 120 onto a single TFT array substrate 210 is completed, the inkjet head portion 120 returns to its original position to prepare the ejecting of the alignment material solution from the inkjet head portion 120 onto a subsequent TFT array substrate, as shown in FIG. 8C. Since the inkjet head portion 120 moves reciprocally in a substantially perpendicular direction to the row direction (β) of the TFT array TA, it is preferable that the length of the inkjet head portion 120 is at least greater than the width of the TFT array substrate 210 to eject an alignment material solution from the inkjet head portion 120 on the entire surface of the TFT array substrate 210.

A plurality of nozzles 122, shown in FIGS. 3A and 3B, of the inkjet head portion 120 can be independently opened or closed. Thus, the ejecting of an alignment material solution from the inkjet head portion 120 can be controlled in such a way that nozzles 122 corresponding to areas of the TFT array substrate 210 intended for alignment material solution ejecting are opened, whereas nozzles 122 corresponding to areas of the TFT array substrate 210 unintended for alignment material solution ejecting are closed. Also, for example, as the inkjet head portion 120 moves in the direction (γ), some of the nozzles 122 may move past the TFT array substrate 210 and these nozzles 122 may be closed while nozzles 122 still over the TFT array substrate 210 may remain open.

Finally, the alignment layers 219 and 225 formed respectively on the TFT array substrate 210 and the color filter substrate 220 are rubbed followed by liquid crystal material injection to thereby complete an LCD 200.

Therefore, as described above, according to the present invention, generation of stripes on a display panel can be prevented even without a substantial modification of a commercially available inkjet-based alignment layer formation apparatus in which a nozzle pitch is greater than a pitch between stepped patterns formed on a substrate, enabling LCDs to be fabricated in a cost-effective manner. Also, according to the present invention, the substrate including stepped patterns can be covered with an alignment layer having uniform thickness.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects.

What is claimed is:

1. A method of fabricating a display, the method comprising:
preparing a substrate comprising a matrix-type array of a plurality of stepped patterns having a predetermined pitch; and
forming a layer substantially covering the front surface of the substrate by ejecting a liquid material from an inkjet head portion onto the substrate in a state wherein a relative movement direction of the substrate to the inkjet head portion and a first direction of the matrix-type array form an angle greater than 0 degrees and less than 90 degrees.

2. The method of claim 1, wherein the first direction corresponds to a row direction of the matrix-type array.

3. The method of claim 1, further comprising disposing the substrate on a stage and moving the stage in a direction parallel to the first direction.

4. The method of claim 1, further comprising disposing the substrate on a stage and moving the stage past the inkjet head portion, wherein the inkjet head portion is fixed and the first direction is not parallel with a moving direction of the stage.

5. The method of claim 1, wherein the substrate moves in the first direction of the matrix-type array and the inkjet head portion moves in a second direction of the matrix-type array.

6. The method of claim 5, wherein the first direction corresponds to a row of the matrix-type array and the second direction corresponds to a column of the matrix-type array.

7. The method of claim 5, wherein the inkjet head portion moves reciprocally in the second direction.

8. The method of claim 1, wherein a thickness of the layer is substantially uniform.

9. The method of claim 1, wherein a generation of stripes on the display is prevented by preventing a regular alternation of a surplus of liquid material and a shortage of liquid material within stepped patterns on the substrate.

10. A method of fabricating a liquid crystal display, the method comprising:
preparing a substrate comprising a matrix-type array of a plurality of stepped patterns having a predetermined pitch; and
forming an alignment layer on the substrate by ejecting an alignment material solution from an inkjet head portion onto the substrate in a state wherein a relative movement direction of the substrate to the inkjet head portion and a first direction of the matrix-type array form an angle greater than 0 degrees and less than 90 degrees.

11. The method of claim 10, further comprising disposing the substrate on a stage and moving the stage in a direction parallel to the first direction.

12. The method of claim 10, further comprising disposing the substrate on a stage and moving the stage past the inkjet head portion, wherein the inkjet head portion is fixed and the first direction is not parallel with a moving direction of the stage.

13. The method of claim 10, wherein a generation of stripes on the liquid crystal display is prevented by preventing a regular alternation of a surplus of alignment material solution and a shortage of alignment material solution within the plurality of stepped patterns.

14. The method of claim 10, wherein the substrate comprises a plurality of thin film transistors.

15. The method of claim 10, wherein a pitch between nozzles of the inkjet head portion is greater than a predetermined pitch between the stepped patterns.

16. The method of claim 10, wherein the angle is in a range from 3 to 45 degrees.

17. The method of claim 16, wherein the angle is determined by a movement velocity of the substrate and a movement velocity of the inkjet head portion.

18. The method of claim 17, wherein the substrate moves in the first direction of the matrix-type array and the inkjet head portion moves in a second direction different from the first direction of the matrix-type array.

19. The method of claim 18, wherein the first direction of the matrix-type array is substantially perpendicular to the second direction.

20. The method of claim 18, wherein the inkjet head portion moves reciprocally in the second direction.

21. The method of claim 10, wherein each of the plurality of stepped patterns has a step height of 3 μm or more.

22. The method of claim 21, wherein the plurality of the stepped patterns are contact holes electrically connecting drain electrodes and pixel electrodes of a plurality of thin film transistors.

23. An apparatus for forming a layer, the apparatus comprising:
a stage moving a substrate disposed thereon in a first direction, the substrate comprising a thin film transistor array in which a plurality of thin film transistors are arranged in a matrix; and
an inkjet head portion, positioned above the stage, ejecting a liquid material onto the substrate,
wherein a relative movement direction of the substrate to the inkjet head portion and one direction of the thin film transistor array form an angle greater than 0 degrees and less than 90 degrees.

24. The apparatus of claim 23, wherein the inkjet head portion comprises at least one block-type head comprising a plurality of nozzles.

25. The apparatus of claim 24, wherein a pitch between nozzles of the inkjet head portion is greater than a pitch between the stepped patterns arranged along one direction of the thin film transistor array.

26. The apparatus of claim 23, wherein the layer is an alignment layer.

27. The apparatus of claim 23, wherein the liquid material is an alignment material solution.

28. An apparatus for forming an alignment layer on a substrate, the substrate comprising a thin film transistor array in which a plurality of thin film transistors are arranged in a matrix, the apparatus comprising:
a stage moving the substrate disposed thereon in a first direction,; and
an inkjet head portion, positioned above the stage, ejecting an alignment material solution onto the substrate,
wherein a relative movement direction of the substrate to the inkjet head portion and one direction of the thin film transistor array form an angle greater than 0 degrees and less than 90 degrees.

29. The apparatus of claim 28, wherein the first direction and the one direction of the thin film transistor are parallel.

30. The apparatus of claim 28, wherein the inkjet head portion is fixed and neither a row direction nor a column direction of the thin film transistor array is parallel to a moving direction of the stage.

31. The apparatus of claim 28, wherein the angle is in a range from 3 to 45 degrees.

32. The apparatus of claim 28, wherein the inkjet head portion moves reciprocally in a second direction.

33. The apparatus of claim 32, wherein the second direction is substantially perpendicular to the first direction.

34. The apparatus of claim 28, wherein the angle is determined by a movement velocity of the substrate and a movement velocity of the inkjet head portion.

35. The apparatus of claim 28, wherein the inkjet head portion comprises at least one block-type head comprising a plurality of nozzles.

36. The apparatus of claim 35, wherein a pitch between nozzles of the inkjet head portion is greater than a pitch between the stepped patterns arranged along one direction of the thin film transistors array.

37. The apparatus of claim 35, wherein the plurality of nozzles of the at least one block-type head are independently opened or closed.
